(19) United States
(12) Patent Application Publication
(10) Pub. No.: US 2005/0030759 A1
(43) Pub. Date: Feb. 10, 2005

(54) Bifocal hyperbolic catadioptric collection system for an automotive lamp

(75) Inventor: Michael W. Zollers, Fishers, IN (US)

Correspondence Address: RUSSELL E. FOWLER, II, ICE MILLER, ONE AMERICAN SQUARE, BOX 82001, INDIANAPOLIS, IN, 46282-0002, US

(73) Assignee: Guide Corporation, Pendleton, IN (US)

(21) Appl. No.: 10/633,792

(22) Filed: Aug. 4, 2003

(51) Int. Cl. F21V 5/00

(52) U.S. Cl. 362/520

(57) ABSTRACT

An automotive lamp assembly includes a light source and a hyperbolic reflector positioned to reflect light from the light source. A bifocal lens is positioned in front of the light source and hyperbolic reflector such that it receives light emitted from the light source and light reflected off the reflector. The bifocal lens includes a first portion having a focal point at the light source and a second portion having a focal point at a virtual focus of the reflector. When the light source is energized and emits light, direct light from the light source strikes the first portion of the lens and collimates the light substantially parallel to the optical axis. Light from the reflector strikes the second portion of the lens and is collimated substantially parallel to the optical axis. Altogether, the light passing through the bifocal lens provides a desirable light beam for an automotive vehicle.

### BACKGROUND

Automotive tail lamps and headlamps direct light from the light source into a desired beam pattern using either a reflector or a lens, or a combination of the two. Typical automotive tail lamp and headlamp designs include a light source positioned within the reflector to emit light on to the reflective surface of the reflector. Optionally, and depending upon the type of reflector used, a lens may be positioned in front of the light source with a prescription that manipulates the reflected light into a desired beam pattern. The light source itself is often hidden behind a light shield and/or decorative cap such that direct light from the light source is not included in the resulting light beam emitted from the lamp. The light source may be hidden for any of several reasons. For example, direct light that has not reflected off the reflector surface may be difficult to control and use in the desired beam pattern. Other reasons for omitting a light shield include stylization options and reduction of glare. When a light shield/decorative cap is used, the only light that escapes the lamp is light that is reflected off the surface of the reflector. However, the amount of light that is blocked by the light shield and/or decorative cap results in a lamp with a low collection efficiency (i.e., the lamp does not efficiently collect light from the light source for contribution to the desired beam pattern). Of course, a lamp with low collection efficiencies is undesirable because of the energy wasted by the lamp. Accordingly, it would be desirable to provide an improved lamp with high collection efficiencies that provides a well-focused beam of light and does not result in unwanted glare.

An automotive lamp assembly is disclosed herein comprising a light source and a hyperbolic reflector positioned to reflect light from the light source. A bifocal lens is positioned in front of the light source and hyperbolic reflector such that the bifocal lens receives light emitted from the light source and light reflected off the reflector. The bifocal lens includes a first portion having a focal point at or near the light source and a second portion having a focal point at or near a virtual focus of the reflector. The first portion of the lens is located near the center of the lens and the second portion of the lens is concentric with and at least partially surrounds the first portion of the lens. The first and second portions are integral with each other such that the lens forms a unitary piece. When the light source is energized and emits light, direct light from the light source passes through the first portion of the lens and the lens collimates the light. Light from the reflector strikes the second portion of the lens and is collimated substantially parallel to the light passing through the first portion of the lens.

### BRIEF DESCRIPTION OF THE DRAWINGS

FIG. 1 shows a top view of one embodiment of a Bifocal Hyperbolic Catadioptric Collection System for an automotive vehicle; and

FIG. 2 shows a top view of another embodiment of the Bifocal Hyperbolic Catadioptric Collection System of FIG. 1 including a light shield.

### DESCRIPTION

The invention described herein relates generally to a tail lamp or headlamp system for an automotive vehicle. In particular, the subject invention relates to a tail lamp or headlamp assembly including a bifocal lens for collecting both direct and reflected light from the light source, and resulting in a high collection efficiency.

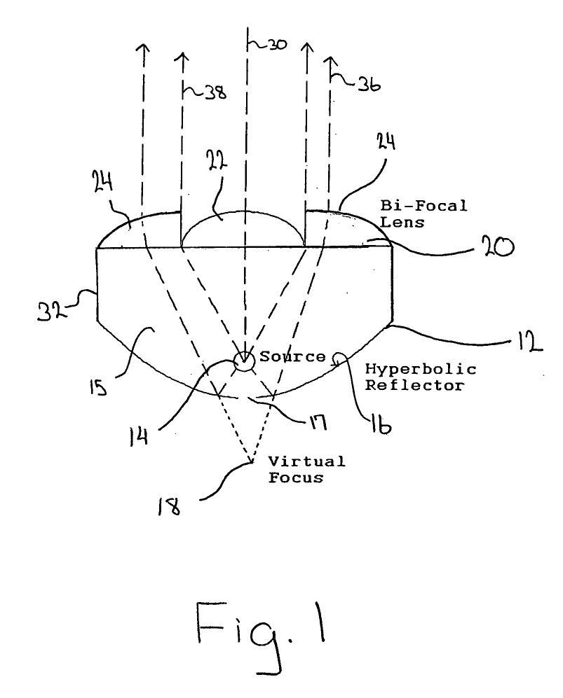

As shown in FIG. 1, a lamp assembly includes a reflector 12, a light source 14 and a bifocal lens 20. The reflector 12 is hyperbolic in shape (e.g., a hyperboloid) and includes a reflective surface 16 that faces the light source 14. The reflective surface 16 of the hyperbolic reflector defines an interior lamp cavity 15. A socket mounting hole 17 is formed at the apex of the hyperbolic reflector for receiving a lamp socket (not shown) which holds the light source 14. The light source is positioned within the interior lamp cavity 15 when the lamp socket is inserted into the mounting hole. Depending on the size of the reflective surface, sidewalls 32 may be included on the reflector that extend the reflector to the bifocal lens. The sidewalls 32 also define the interior lamp cavity 15. The interior surface of the sidewalls 32 are generally non-reflective and are designed to absorb any light that strikes the sidewall.

The light source 14 is positioned within the interior lamp cavity 15 such that it emits light on to the reflective surface 16 of the reflector (e.g., see ray trace 36). The light source also emits light away from the reflector 12 such that it does not strike the reflective surface (e.g., see ray trace 38). Light reflected from the hyperbolic reflector 12 diverges and appears to emanate from the virtual focus 18 of the hyperbolic reflector, which is located behind the reflector 12. Of course, light that does not strike the reflector appears to emanate from the light source itself. The light source is an incandescent light bulb, as is common in many automotive headlamp and tail lamp applications. However, any number of different light sources may also be used as the light source, including but not limited to, one or more light emitting diodes (LEDs), halogen lamps, or high intensity discharge lamps (HIDs).

The bifocal lens 20 is positioned in front of the light source and reflector 12. The bifocal lens is positioned against the end of the reflector 12, or reflector sidewalls 32, and defines the front boundary of the lamp cavity. The bifocal lens 20 includes a centrally located first portion 22 and a peripheral second portion 24 that completely or partially surrounds the first portion. The bifocal lens 20 is a condensing lens. The first portion 22 of the bifocal lens has a focal point at the light source, such that it collimates direct light received from the light source. Accordingly, most of the light passing through the first portion 22 of the bifocal lens is collimated such that the light rays are substantially parallel to the optical axis 30 of the lamp. The second portion of the bifocal lens has a focal point at the virtual focus 18 of the hyperbolic reflector, such that it collimates the diverging light reflected from the hyperbolic reflector. Accordingly, most of the light passing through the second portion 24 of the lens is collimated such that the light rays are collimated substantially parallel to the optical axis. Together, the collimated light from the first portion and second portion of the bifocal lens forms a desired beam pattern. It should be noted that the terms “at the light source” and “at the virtual focus” as used herein are intended to describe the location of a lens focal point that it sufficiently near the light source or virtual focus such that the lens substantially collimates the light emanating (or appearing to emanate) from the light source or virtual focus.

Accordingly, the bifocal hyperbolic catadioptric collection system provides a lamp assembly that collects and collimates nearly all light emitted from the light source. Because no bulb shield is provided between the light source and the bifocal lens, nearly all of the light emitted from the light source contributes to the beam pattern, resulting in a highly efficient lamp. Even greater efficiencies may be realized if any non-reflective portions of the reflector (e.g., the sidewall 32) are eliminated or reduced, by extending the reflective surface 16 of the sidewall all the way to the lens 20.

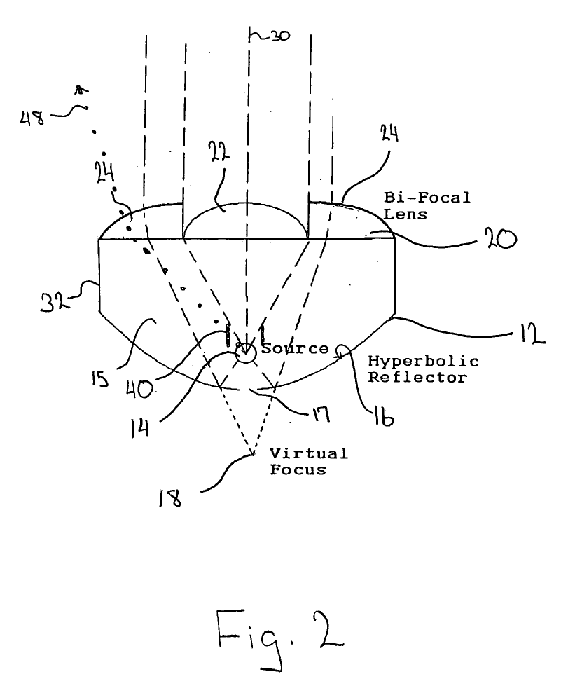

It should be noted that some of the light from the light source 14 that does not strike the reflector will strike the second portion 24 of the lens 20 and not the first portion 22 of the lens 20. Because this light does not appear to emanate from the virtual focus 18, which is the focal point of the second portion of the lens, it will not be properly collimated by the second portion of the lens. Dotted line 48 in FIG. 2 shows a ray trace representative of such light. Although this light will be bent in the direction of the optical axis by the second portion of the lens, it will not be collimated in the same manner as the light reflected off the reflector. Because this light is not totally controlled, it may add an undesirable characteristic to the beam pattern coming from the lamp assembly. Therefore, in one alternative embodiment of the invention shown in FIG. 2, a light shield 40 is provided to block direct light from the light source striking the second portion of the lens (such as the light represented by ray trace 48). This light shield 40 may take the form of a cylindrical shield that allows light to pass through its cylindrical ends, thereby allowing direct light to pass through the first portion of the lens and reflected light to pass through the second portion of the lens, but blocking direct light from passing through the second portion of the bifocal lens.

Although the above lamp assembly has been described in considerable detail with reference to certain preferred versions thereof, other versions are possible. For example, as mentioned above, the lamp assembly may or may not include some form of light shield. As another example, reflector 12 may or may not include sidewall portions 32. Therefore, the spirit and scope of the appended claims should not be limited to the description of the preferred versions contained herein.

1. An automotive lamp comprising:
a. a light source;
b. a reflector positioned to reflect light from the light source; and
c. a lens positioned to receive light emitted from the light source and light reflected off the reflector, the bifocal lens comprising
(i) a first portion having a focal point at the light source; and
(ii) a second portion having a focal point at a virtual focus of the reflector.

2. The automotive lamp of claim 1 wherein the shape of the reflector is hyperbolic.

3. The automotive lamp of claim 1 wherein the first portion of the lens is located near the center of the lens.

4. The automotive lamp of claim 3 wherein the second portion of the lens at least partially surrounds the first portion of the lens.

5. The automotive lamp of claim 4 wherein the second portion of the lens is concentric with the first portion of the lens.

6. The automotive lamp of claim 1 where in the first portion of the lens is integral with the second portion of the lens such that the lens is a unitary piece.

7. The automotive lamp of claim 1 wherein the first portion of the lens collimates light emitted from the light source and the second portion of the lens collimates light reflected from the reflector.

8. A method of providing a beam of light for an automotive lamp, the method comprising:
a. providing a light source, a reflector and a bifocal lens, the lens comprising a first portion having a focal point at the light source and a second portion having a focal point at a virtual focus of the reflector; and
b. energizing the light source such that light is emitted from the light source and reflected off the reflector, thereby causing light to pass through the bifocal lens and provide a substantially collimated beam of light.

9. The method of claim 8 where the reflector is hyperbolic in shape.

10. The method of claim 8 where the first part of the bifocal lens and the second part of the bifocal lens are integral to form a unitary piece.

11. The method of claim 8 where the substantially collimated beam of light serves as an automotive headlamp.

12. The method of claim 8 where the substantially collimated beam of light serves as an automotive tail lamp.

13. An automotive lamp comprising:
a. a light source;
b. a reflector positioned to reflect light from the light source, wherein light emitted from the reflector appears to emit from a virtual focus; and
c. a means for collimating the light emitted from the light source and reflected off the reflector, the means for collimating light including a first focal point at the light source and a second focal point at the virtual focus.

14. The automotive lamp of claim 13 wherein the shape of the reflector is hyperbolic.

15. The automotive lamp of claim 13 wherein the means for collimating light is a bifocal lens includes a first portion and a second concentric portion.

16. The automotive lamp of claim 15 wherein the first portion of the lens is integral with the second portion of the lens such that the lens is a unitary piece.
